(19) United States
(12) Patent Application Publication
(10) Pub. No.: US 2012/0331100 A1
(43) Pub. Date: Dec. 27, 2012

(54) ELECTRONIC BOOK AND SYSTEM FOR DOWNLOAD OF ELECTRONIC DOCUMENT

(75) Inventor: Jaehong Park, Seoul (KR)

(73) Assignee: LG INNOTEK CO., LTD., Seoul (KR)

(21) Appl. No.: 13/504,853

(22) PCT Filed: Oct. 27, 2010
(86) PCT No.: PCT/KR10/07404

§ 371 Date: Aug. 1, 2012

(30) Foreign Application Priority Data
Oct. 28, 2009 (KR) 10-2009-0102734

(51) Int. Cl. G06F 15/16

(52) U.S. Cl. 709/217

(57) ABSTRACT

A system for download of electronic document is characterized by: an electronic document providing server coding an electronic document and transmitting the coded electronic document to a relevant electronic book terminal using an intrinsic identification (ID) information of a connected electronic book terminal if there is a download request of a particular electronic document; and an electronic book terminal retrieving a particular electronic document by being connected to the electronic document providing server in response to an externally-inputted command, downloading the coded electronic document from the electronic document providing server in response to the download request of the retrieved particular electric document, and decoding the downloaded electronic document using the intrinsic ID information and displaying the decoded electronic document.

### TECHNICAL FIELD

The present invention relates to an electronic book terminal, and more particularly to an electronic book and system for download of electronic writing capable of downloading a particular electronic document from an electronic book terminal.

### BACKGROUND ART

An electronic book terminal (e-book) is a device capable of showing to a user electronic information including paper printed book contents through display means, and allowing the user to read and edit the displayed information. That is, the e-book is imaginary means capable of rendering electronic documents stored in information storage means for the user to read per page. The electronic documents are provided commercially or non-commercially on networks such as internet, and can be downloaded to an e-book through the network and an e-book can obtain and store new electronic documents.

Recently, concomitant with fast propagation and distribution of computers and internet, the electronic documents are now generalized form of life. Almost all the paper documents such as conventional books, notes, accounting books and the like are replaced by software electronic documents. The electronic documents can be easily copied, swiftly distributed regardless of geographic or time-wise limitation through communication networks and perfectly preserved to dispense with a large physical space for storage. Therefore, it is expected that manufacturing and distribution of electronic documents will gradually expand due to many advantages incomparable to those of the conventional paper documents.

The mobile phones, PDAs (Personal Digital Assistants) and personal computers may be also employed for an e-book. That is, any device may be an e-book as long as visually-readable electronic documents are digitalized in a given format, readable from a stored recording medium and displayed.

Various commercial transactions and information provision are enabled through internet to cater to the trend, and various multimedia technologies enable the conventional printed books using paper to be distributed in e-books under the changing network environments.

However, the conventional e-book suffers from a disadvantage in that a particular electronic document is retrieved and downloaded from web sites through a personal computer and the downloaded electronic document is again transferred to the e-book. The downloading of electronic document using a personal computer makes it impossible for a computer-less environment or an environment in motion to download the electronic document.

### DISCLOSURE OF INVENTION

### Technical Problem

The present invention is disclosed to provide an electronic book and system for download of electronic document capable of directly downloading a particular electronic document by being wirelessly connected to an electronic document providing server, using a wireless communication module mounted to an electronic book terminal.

The disclosed technical concepts should not be construed as limited to those set forth herein. Other technical concepts not disclosed herein may be well understood and apparent to those skilled in the art having the benefit of the teachings herein.

### Solution to Problem

The present invention is disclosed to solve the aforementioned problems and it is an object of the present invention to provide an electronic book and system for download of electronic document.

In one general aspect of the present invention, an electronic book terminal may comprise: a memory stored with intrinsic identification (ID) information and various electronic documents; input means for website connection and inputting various commands for book downloading; a wireless communication module connected to an electronic document providing server through a wireless communication network to receive and transmit the intrinsic ID information and various electronic documents; and a controller connected to the electronic document providing server through the wireless communication module in response to a command inputted from the input means, and transmitting the stored intrinsic ID information to the electronic document providing server if a download command is inputted to a particular electronic document retrieved from the electronic document providing server, and decoding downloaded electronic document using the intrinsic ID information if a coded electronic document is downloaded from the electronic document providing server and displaying the decoded electronic document.

In some exemplary embodiment, the intrinsic ID information may include at least any one of an intrinsic serial number of a terminal, an entry ID and a password of the electronic document providing server.

In some exemplary embodiment, the electronic book terminal may further include a wired interface for being connected to the electronic document providing server through internet by being wiredly connected to an external personal computer.

In some exemplary embodiment, the controller may include a web browser driving unit transmitting a web page to a pre-set IP address by being connected to a relevant electronic document providing server if a web connection command is inputted from the input means, a download requesting unit requesting a download by transmitting a pre-set intrinsic ID information to the electronic document providing server if a download command to a particular electronic document retrieved via a web page transmitted from the electronic document providing server is inputted, and a decoder decoding an electronic document downloaded and coded by the electronic document providing server using the intrinsic ID information and displaying the decoded electronic document.

In another general aspect of the present invention, a system for download of electronic writing may comprise: an electronic document providing server coding an electronic document and transmitting the coded electronic document to a relevant electronic book terminal using an intrinsic identification (ID) information of a connected electronic book terminal if there is a download request of a particular electronic document; and an electronic book terminal retrieving a particular electronic document by being connected to the electronic document providing server in response to an externally-inputted command, downloading the coded electronic document from the electronic document providing server in response to the download request of the retrieved particular electric document, and decoding the downloaded electronic document using the intrinsic ID information and displaying the decoded electronic document.

### Advantageous Effects of Invention

The present invention is advantageous in that an electronic document can be downloaded by being directly connected to an electronic document providing server by mounting a wireless communication module to an electronic book terminal to greatly enhance user convenience due to easy book retrieving and downloading even in motion or outside of a building.

### BRIEF DESCRIPTION OF DRAWINGS

FIG. 1 is a schematic view illustrating a system for download of electronic document according to the present invention.

FIG. 2 is a functional block diagram illustrating a detailed construction of an electronic book terminal for downloading electronic document according to an exemplary embodiment of the present invention.

FIG. 3 is a schematic view illustrating a download process of electronic document according to the present invention.

### BEST MODE FOR CARRYING OUT THE INVENTION

The exemplary embodiments of the present invention will be described in detail with reference to the accompanying drawings, where like reference numerals refer to like parts throughout the description of several views of the drawings. In describing the present invention, detailed descriptions of constructions or processes known in the art may be omitted to avoid obscuring appreciation of the invention by a person of ordinary skill in the art with unnecessary detail regarding such known constructions and functions.

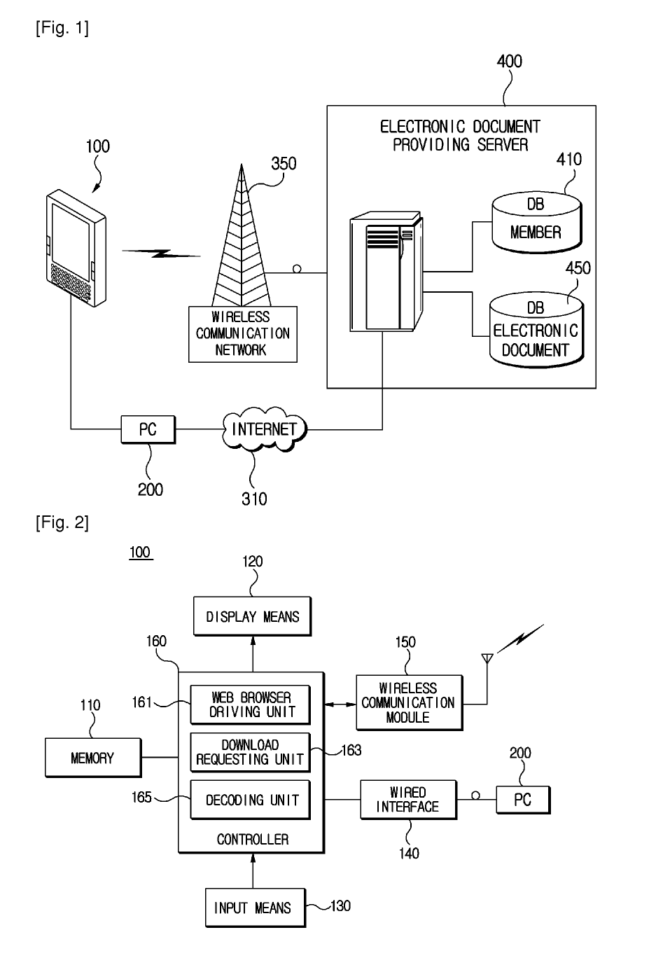

FIG. 1 is a schematic view illustrating a system for download of electronic document according to the present invention, where the system may include an electronic book terminal (100), a personal computer (200, PC) and an electronic document providing server (400).

The electronic book terminal (100) retrieves a particular electronic document by being connected to the electronic document providing server (400) through wired and wireless communication networks (310, 350), downloads a coded electronic document from the electronic document providing server (400) if download of the retrieved particular electronic document is selected, and decoding the downloaded electronic document using intrinsic ID information, and storing and displaying the decoded electronic document. The electronic book terminal (100) may be a portable terminal, a mobile terminal, PDA or a mobile computer.

The electronic document providing server (400) decodes a selected electronic document using intrinsic ID information after a membership authentication and transmits the decoded electronic document to the electronic book terminal (100) if there is a download request of a particular electronic writing from a connected electronic book terminal (100).

That is, the electronic document providing server (400) performs a membership authentication in response to intrinsic ID information transmitted from the electronic book terminal (100) if there is a download request of a particular electronic document from the electronic book terminal (100), retrieves and extracts a selected electronic document from an electronic document database (450) if the membership authentication is completed, codes the selected electronic document using the intrinsic ID information and transmits the coded electronic document to the electronic book terminal (100).

The membership information may include subscriber information such as a residential registration number, a name, an address, a bank account number, and intrinsic ID information such as intrinsic serial number or an ID and a password provided at the time of membership entry, where the intrinsic ID information is shared by the electronic book terminal (100) and the electronic document providing server (400) for coding and decoding of electronic document and membership authentication. The electronic book terminal (100) and the electronic document providing server (400) may be interconnected through the wireless communication network (350) or through the internet (310). At this time, in a case the electronic book terminal (100) and the electronic document providing server (400) are interconnected through the internet (310), the interconnection is performed under the relay of a personal computer (200). For example, the electronic book terminal (100) and the personal computer (200) are interconnected via wire connection (e.g., USB interface), and the personal computer (200) and the electronic document providing server (400) are interconnected through the internet (310).

The electronic book terminal (100) transmits intrinsic ID information such as a pre-stored serial number, an ID and a password to the electronic document providing server (400) if a download of a retrieved particular electronic document is selected by the electronic document providing server (400), where the electronic document providing server (400) uses the intrinsic ID information transmitted from the electronic book terminal (100) to code the selected electronic document and download the coded electronic document to a relevant electronic book terminal (100). As a result, the electronic book terminal (100) uses the intrinsic ID information and decodes the electronic document for use.

Meanwhile, the wireless communication network (350) forms a wireless channel with the electronic book terminal (100) to interconnect the electronic book terminal (100) and the electronic document providing server (400) in response to an IP (Internet Protocol) address or a telephone number transmitted from the electronic book terminal (100). The wireless communication network (350), although not illustrated in detail, may include a base station receiving writing information and a base station controller controlling and managing at least one or more base stations to transmit the writing information transmitted from each electronic book terminal (100) through the base station to PDSN (Packet Data Serving Node) or MSC (Mobile Switching Center). A gateway for converting the communication protocol may be included between the wireless communication network (350) and the internet in a case the wireless communication network (350) is connected to the electronic document providing server (400) via the internet.

FIG. 2 is a functional block diagram illustrating a detailed construction of an electronic book terminal for downloading electronic document according to an exemplary embodiment of the present invention, where the electronic book terminal (100) may include a memory (110), display means (120), input means (130), a wired interface (140), a wireless communication module (150) and a controller (160).

The memory (110) may be stored with any one of the intrinsic ID information comprising an intrinsic serial number, identification (ID) and a password of the terminal, am URL (Uniform Resource Locator) address of the electronic document providing server (400) or an IP address, and various electronic documents. The display means (120) displays web pages connected to the electronic document or on-line in response to a control signal.

The input means (130) may include a keypad for inputting various commands for controlling web connection, writing download and screen. A keyboard or a touch panel may be employed for the input means (130).

The wired interface (140) may be a serial interface such as USB performing data communication by being wiredly connected to the personal computer (200). The wired interface (140) is a device of the electronic book terminal (100) for receiving a particular electronic document by being wiredly connected to the electronic document providing server (400) via the personal computer (200).

The wireless communication module (150) is a 3G (Generation) modem unit capable of transmitting intrinsic ID information and electronic document to the electronic document providing server (400) and receiving the intrinsic ID information and electronic document from the electronic document providing server (400) by performing a wireless communication with the wireless communication network (350).

Although the present exemplary embodiment has described the wireless communication module (150) as a 3G modem unit connecting to the electronic document providing server (400) via the wireless communication network (350), it is not limited thereto. For example, the wireless communication module (150) may be a short distance communication module performing a short distance wireless communication such as wireless LAN module, Wibro module, Bluetooth, UWB (Ultra Wideband) or Zigbee. In a case the wireless communication module (150) is a wireless LAN module or a Wibro module, the electronic book terminal (100) may be connected to the electronic document providing server (400) via internet, and in a case the wireless communication module (150) is a short distance communication module, the electronic book terminal (100) may be directly connected to the electronic document providing server (400) dispensing with the wired and wireless communication network (310, 350).

The controller (160) is connected to the electronic document providing server (400) via the wired and wireless communication network (310, 350) in response to a command inputted from the input means (130), transmits to the electronic document providing server (400) stored intrinsic ID information in a case a download command to a retrieved particular electronic document is inputted from the electronic document providing server (400), and decodes, stores and displays the downloaded electronic document using the intrinsic ID information in a case a coded electronic document is downloaded from the electronic document providing server (400).

The controller (160) may include a web browser driving unit (161), a download requesting unit (163) and a decoding unit (165). The web browser driving unit (161) receives web pages by connecting to a relevant electronic document providing server (400) using a pre-set IP address in a case a web connection command is received from the input means (130).

The download requesting unit (163) requests the download by transmitting a pre-stored intrinsic ID information to the electronic document providing server (400) in a case a download command of a particular electronic writing retrieved via the web page transmitted from the electronic document providing server (400) is inputted from the input means (130).

The decoding unit (165) decodes, stores and displays the electronic document downloaded and coded by the electronic document providing server (400) using intrinsic ID information. The decoding unit (165) may use the intrinsic ID information and decode in a case the electronic document downloaded from the electronic document providing server (400) is stored in the memory (110), the electronic writing being coded, and the stored electronic document is displayed on the display means (120).

### MODE FOR THE INVENTION

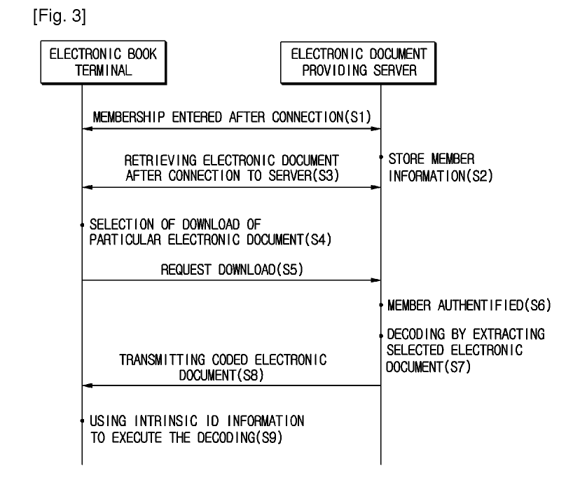

Now, an operational process of the system for download of electronic document thus configured will be described in detail with reference to FIG. 3.

First, the electronic book terminal (100) drives the web browser driving unit (161) in response to the web browser command inputted from the input means (130) for connection to a predetermined electronic document providing server (400) and transmits to the electronic document providing server (400) membership information inputted in accordance with a membership entry procedure of the predetermined electronic document providing server (400) (S1).

As a result, the electronic document providing server (400) stores the membership information inputted to the web page in a membership database (410) (S2).

The membership information may include subscriber information such as a residential registration number, a name, an address, a bank account number of the member, and intrinsic ID information such as intrinsic serial number or an ID and a password provided at the time of membership entry, where the intrinsic ID information is shared by the electronic book terminal (100) and the electronic document providing server (400) for coding and decoding of electronic document and membership authentication.

Successively, the electronic book terminal (100) drives the web browser driving unit (161) in response to the web browser command inputted from the input means (130) for connection to the electronic document providing server (400) using a pre-set IP address through wired and wireless communication networks (310, 350) and receives a web page from the electronic document providing server (400) (S3).

The electronic document providing server (400) retrieves from the database (450) information on a relevant electronic document in response to a retrieving command of a particular electronic document via a web page from the electronic book terminal (100) and transmits the information to the electronic book terminal (100). Successively, the electronic book terminal (100) transmits the stored intrinsic ID information to the electronic document providing server (400) and requests the download in a case the download request command is inputted from the input means on a relevant electronic document (130) (S4, S5).

The electronic document providing server (400) uses the intrinsic ID information transmitted from the electronic book terminal (100) to perform the membership authentication (S6), and extracts the selected electronic document, codes the electronic document using the intrinsic ID information if the membership authentication is completed, transmits the coded electronic document to a relevant electronic book terminal (100) and downloads the coded electronic document (S7, S8).

Thereafter, the electronic book terminal (100) stores in the memory (110) the coded electronic document downloaded from the electronic document providing server (400), decodes the coded electronic document using the intrinsic ID information and displays the decoded electronic document in a case the relevant decoded electronic document is displayed on the display means (120) (S9). If the intrinsic ID information contained in the electronic document and the intrinsic ID information stored in the electronic book terminal (100) are different, the electronic document is not displayed.

As apparent from the foregoing, a particular electronic document can be downloaded by the electronic document terminal (100) being directly connected to an electronic document providing server (400) via wired or wireless communication network (310, 350) to greatly enhance user convenience due to easy book retrieving and downloading even in motion or outside of a building or an environment deprived of internet.

The exemplary embodiment has described the electronic book terminal (100) being connected to the electronic document providing server (400) through the wireless communication network (350), where the wireless communication network (350) may be a mobile communication network or a Wibro network.

In addition, in a case the electronic book terminal (100) and the electronic document providing server (400) are situated in a short distance within a same bookstore, the electronic book terminal (100) can directly communicate with the electronic document providing server (400) using a short distance wireless communication such as Bluetooth, UWB and Zigbee, where the wireless communication module (150) of the electronic book terminal (100) may be a short distance communication module.

Although the present invention has been described with reference to an illustrative embodiment thereof, it should be understood that numerous other modifications and embodiments can be devised by those skilled in the art that which fall within the spirit and scope of the principles of this disclosure. More particularly, various variations and modifications are possible in the component parts and/or arrangements of the subject combination arrangement within the scope of the invention, the drawings and the appended claims. In addition to variations and modifications in the component parts and/or arrangements, alternative uses will also be apparent to those skilled in the art.

### INDUSTRIAL APPLICABILITY

There is an industrial applicability in the present invention in that a particular electronic document can be downloaded by the electronic document terminal being directly connected to an electronic document providing server via wired or wireless communication network to greatly enhance user convenience due to easy book retrieving and downloading even in motion or outside of a building or an environment deprived of interne.

1. An electronic book terminal, comprising: a memory stored with intrinsic identification (ID) information and various electronic documents; input means for website connection and inputting various commands for book downloading; a wireless communication module connected to an electronic document providing server through a wireless communication network to receive and transmit the intrinsic ID information and various electronic documents; and a controller connected to the electronic document providing server through the wireless communication module in response to a command inputted from the input means, and transmitting the stored intrinsic ID information to the electronic document providing server if a download command is inputted to a particular electronic document retrieved from the electronic document providing server, and decoding downloaded electronic document using the intrinsic ID information if a coded electronic document is downloaded from the electronic document providing server and displaying the decoded electronic document.

2. The terminal of claim 1, wherein the intrinsic ID information includes at least any one of an intrinsic serial number of a terminal, an entry ID and a password of the electronic document providing server.

3. The terminal of claim 1, further characterized by a wired interface for being connected to the electronic document providing server through internet by being wired connected to an external personal computer.

4. The terminal of claim 1, wherein the controller comprises: a web browser driving unit transmitting a web page to a pre-set IP address by being connected to a relevant electronic document providing server if a web connection command is inputted from the input means; a download requesting unit requesting a download by transmitting a pre-set intrinsic ID information to the electronic document providing server if a download command to a particular electronic document retrieved via a web page transmitted from the electronic document providing server is inputted; and a decoder decoding an electronic document downloaded and coded by the electronic document providing server using the intrinsic ID information and displaying the decoded electronic document.

5. The terminal of claim 1, wherein the wireless communication module is any one of a 3G modem unit, a wireless LAN module, a Wibro module and a short distance communication module.

6. A system for download of electronic document, comprising: an electronic document providing server coding an electronic document and transmitting the coded electronic document to a relevant electronic book terminal using an intrinsic identification (ID) information of a connected electronic book terminal if there is a download request of a particular electronic document; and an electronic book terminal retrieving a particular electronic document by being connected to the electronic document providing server in response to an externally-inputted command, downloading the coded electronic document from the electronic document providing server in response to the download request of the retrieved particular electric document, and decoding the downloaded electronic document using the intrinsic ID information and displaying the decoded electronic document.

7. The system of claim 6, wherein the intrinsic ID information includes at least any one of an intrinsic serial number of a terminal, an entry ID and a password of the electronic document providing server.

8. The system of claim 6, wherein the electronic book terminal transmits to the electronic document providing server pre-stored intrinsic ID information in response to download request of a particular electronic document and requests the download.

9. The system of claim 6, wherein the electronic book terminal comprises: a memory stored with intrinsic identification (ID) information and various electronic documents; input means for website connection and inputting various commands for book downloading; a wireless communication module connected to an electronic document providing server through a wireless communication network to receive and transmit the intrinsic ID information and various electronic documents; and a controller connected to the electronic document providing server through the wireless communication module in response to a command inputted from the input means, and transmitting the stored intrinsic ID information to the electronic document providing server if a download command is inputted to a particular electronic document retrieved from the electronic document providing server, and decoding downloaded electronic document using the intrinsic ID information if a coded electronic document is downloaded from the electronic document providing server and displaying the decoded electronic document.
